(19) United States
(12) Patent Application Publication
(10) Pub. No.: US 2007/0288595 A1
(43) Pub. Date: Dec. 13, 2007

(54) System and Method for Distributing Classified Ads

(75) Inventor: Erez Nissan Cohen, Tel-Aviv (IL)

Correspondence Address: MYERS WOLIN, LLC, 100 HEADQUARTERS PLAZA, North Tower, 6th Floor, MORRISTOWN, NJ, 07960-6834, US

(73) Assignee: SIMPLE - LEAH LEKOL ALUCHOT, LTD, Tel-Aviv (IL)

(21) Appl. No.: 11/757,997

(22) Filed: Jun. 5, 2007

Related U.S. Application Data
(60) Provisional application No. 60/804,172, filed on Jun. 7, 2006.

(51) Int. Cl. G06F 15/16

(52) U.S. Cl. 709/217

(57) ABSTRACT

A system and method for distributing classified ads. The system is capable of simultaneously posting a classified ad to a plurality of websites. Specifically, using the present invention a user (e.g., a seller) is simply required to complete a single form and designate the websites to publish the ad on. The system automatically fills out forms complaint with the designated website and posts these forms.

### CROSS REFERENCE TO RELATED APPLICATION

This application claims the benefit of U.S. provisional application No. 60/804,172 filed on Jun. 7, 2006, which is incorporated by reference in its entirety.

### TECHNICAL FIELD

The present invention relates generally to a system and method for publishing classified ads.

### BACKGROUND OF THE INVENTION

Printed classified advertisements (ads) produced by the print media publishers have proven very useful and cost effective in bringing buyers and sellers together. In particular, newspapers, periodicals and magazines utilize classified advertising to generate revenue from individuals or other relatively small sellers who could otherwise not afford to advertise goods and services they wish to sell. Printed classified ads are often the first stop in seeking for goods or services. However, printed classified ads have their disadvantages. For example, classified ads tend to show limited item description because of the need to save ad space and reduce cost. Additionally, the newspapers are typically incapable of doing anything more than providing minimal classification for the items advertised.

With the rapid growth of the World Wide Web in recent years, a large amount of effort has been devoted to using the Web for advertising. More and more advertisers and consumers are turning to the web to match products and services with consumers, just as more and more employees and employers are using the web to find suitable positions and candidates to fill them. As a result, more and more websites provide bulletin or posting boards for and with a classified ads section where users can advertise products and services or browse through advertisements and make purchases. Such type of classified ads will be referred hereinafter as “web classified ads.”

The web classified ads have many advantages. For example, such ads can be very long in order to properly describe a product. The printed-classified ads are usually priced by length, and thus long ads may be relatively expensive. The web classified ads may include text, image or a short video clip. This provides an advantage as many products (e.g., furniture, clothing, antiques, pets, homes, etc.) are not amenable to advertisement with words only and a photograph may be needed. Furthermore, web classified advertising services provide searching and browsing capabilities allowing buyers to easily locate products and services that address their needs.

In order to publish a web classified ad, a seller first has to browse to the website that provides ads posting services. Next, the seller is prompted to enter item information on each item by filling an information form (e.g., HTML form). This form includes the seller's personal information as well as details about the product for sale. An exemplary information form is shown in FIG. 1. Once the seller completes the information form through entry in fields 110-1 to 110-6, the item information is saved in a database and later displayed on a web page of the website.

As illustrated in FIG. 1 an information form may include many fields to be filled out by the seller. Currently, if the seller wishes to advertise an item in a plurality of websites, the seller may need to repeat the process describe above in each and every website. This is a tedious task that would require the seller to spend a lot of time in posting the web classified ads. Particularly, this affects small sellers (e.g., car dealers) who weekly post hundreds of ads to tens of websites. Consequently, the number of classified ads that are published in a given website is significantly lower from an existing potential. Furthermore, searching for all websites that provide posting services is a tedious task.

It would be therefore advantageous to provide an efficient solution for distributing classified ads.

### SUMMARY OF THE INVENTION

The disclosed invention is intended to overcome the deficiencies of the prior art solutions by providing a system and method for distributing classified ads. Specifically, the system is capable of simultaneously posting a classified ad to a plurality of websites. Using the present invention a user (e.g., a seller) simply completes a single form (hereinafter the “master form”) and designates the websites to publish the ad. The system automatically fills out information forms compliant with the websites and posts these forms.

The invention includes a method for simultaneously distributing a classified advertisement (ad) to a plurality of posting boards. The method includes retrieving a master form filled out by a user; automatically inserting details included in the master form into each information form of each posting board; and sending each of the information form to its respective posting board.

Also described is a computer program product including a computer-readable medium comprising software instructions operable to enable a computer to perform a method for simultaneously distributing a classified advertisement (ad) to a plurality of posting boards.

A system is also described for simultaneously posting a classified advertisement (ad) to a plurality of posting boards hosted by websites.

### BRIEF DESCRIPTION OF THE DRAWINGS

FIG. 1—is an exemplary information form;

FIG. 2—is a diagram of a system for distributing classified ads to a plurality of websites in accordance with an example embodiment of the present invention;

FIG. 3—is a flowchart describing the process for distributing classified ads in accordance with an embodiment of the present invention;

FIGS. 4A, 4B and 4C—are screenshots describing the operation of an example embodiment of the disclosed system;

FIG. 5—is a flowchart describing the process for automatically filling information forms in accordance with an embodiment of the present invention;

FIG. 6—is a flowchart describing the process for generating the FCT and VCT in accordance with the present invention; and

FIG. 7—is a screenshot depicting the fields correlation process.

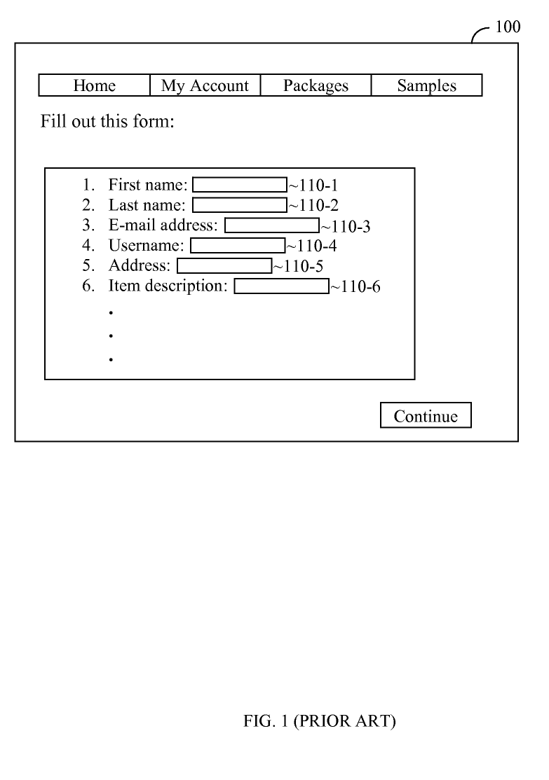

### DETAILED DESCRIPTION OF THE INVENTION

The disclosed invention provides a system and method for distributing classified ads. Specifically, the system is capable of simultaneously posting a classified ad to a plurality of websites. Using the present invention a user (e.g., a seller) is simply completes a single form (hereinafter the “master form”) and designates the websites to publish the ad. The system automatically fills out information forms compliant with the websites and posts these forms.

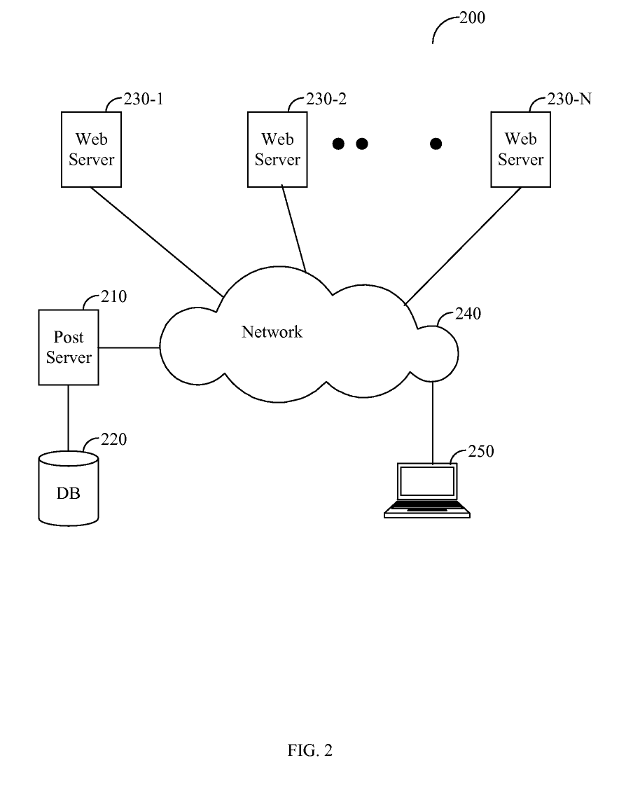

FIG. 2 shows a non-limiting and exemplary diagram of a system 200 for distributing classified ads to a plurality of websites in accordance with an example embodiment of the present invention. System 200 includes a post server 210 coupled to a database 220 and further connected to a plurality of web servers 230-1 through 230-N via a network 240. System 200 also includes a client 250 that can communicate with any of servers 230 or post server 210 via network 240. The web servers 230 and post server 210 may be any of type of computer that provides client stations with access to files as shared resources to a computer network.

Network 240 includes, but is not limited to, the Internet, the World Wide Web, any extranet system, any intranet system, a telecommunications network, a wireless network, a satellite network, or any other private or public network. A client 250 generally denotes a computer or computing means such as, but not limited to, a personal digital assistant (PDA), a mobile phone, a personal computer (PC), a workstation, or any software or hardware process that interconnects by network 240 with one or more servers 210 and 230. Client 250 includes at least a software application that enables the display of computer-originated material, typically received from one or more separate computers or storage media. Preferably, client 250 runs browser software, enabling it to communicate through network 240 to servers 230 or 210. The browser may be Microsoft's Internet Explorer, a commercial or custom-designed browser, or any other or type of client based software allowing access information on network 240. Web servers 230 host the websites that preferably provide bulletin or posting boards for displaying the web classified ads. A user of client 250 can advertise products and services or browse through advertisements and make purchases.

Post server 210 is capable of at least automatically posting a classified ad to a plurality of websites, managing classified ads created by users, and correlating between the master forms and information forms. All of these activities will be described in greater detail below. In accordance with an exemplary embodiment of the present invention post server 210 hosts a website (“posting website”) that provides a portal to posting boards operative on web servers 230. In accordance with one embodiment, the web server 230 may also connect to post server 210 and retrieve classified ads stored therein.

Database 220 includes at least the master forms generated by post server 210, ad templates created by users, and information forms. For each category (e.g., furniture, clothing, antiques, pets, homes, cars, etc.) a single master form is kept in database 220. The ad template is a master form filled out by a user and saved in database 220 for future uses. For example, a car dealer may save an ad template where the personal (or business) information is left unchanged and only the vehicle information (e.g., car type, mileage, etc.) are changed. It should be noted that a user can save a plurality of ad templates. The information forms in database 220 are gathered from websites in web servers 230. When posting a classified ad, post server 210 automatically inserts the details in each of the information forms to be sent to the websites. In an exemplary embodiment a master form, an ad template, and an information form may be a hypertext markup language (HTML) page. The HTML page may be a combination of static HTML-tagged structures and content, such as images, tables and forms, dynamic content coded in Javascript embedded in HTML pages, server side scripts, and one or more Java applets or similar mobile code components embedded in HTML pages.

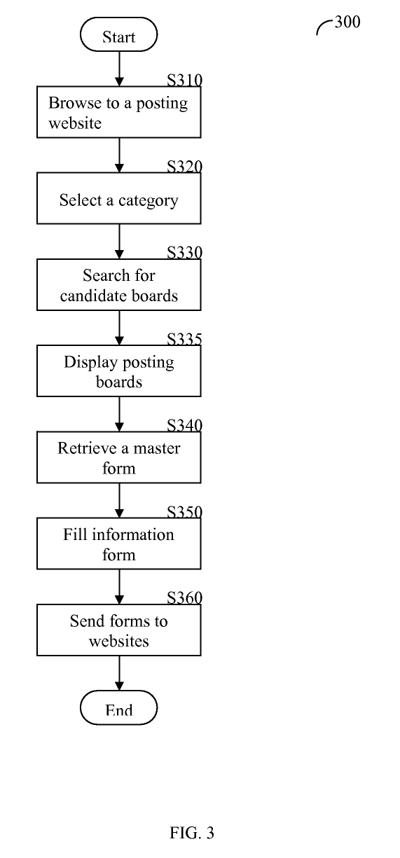

FIG. 3 shows a non-limiting and exemplary flowchart 300 describing the process for distributing classified ads according to one embodiment of the present invention. At S310 a user (e.g., a seller) wishing to publish an ad in multiple websites browses to a posting website that enables the distribution service described herein. In accordance with one embodiment the posting website resides in post server 210. In other embodiments the posting website may be hosted in one of web servers 230 that operates in conjunction with post server 210.

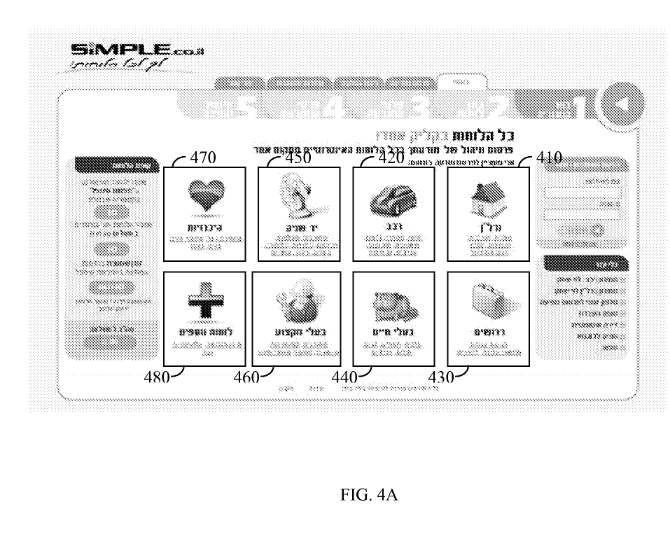

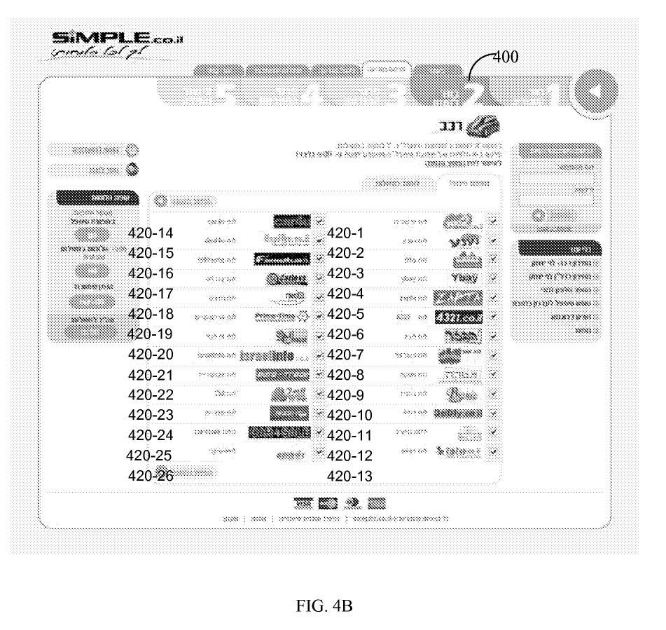

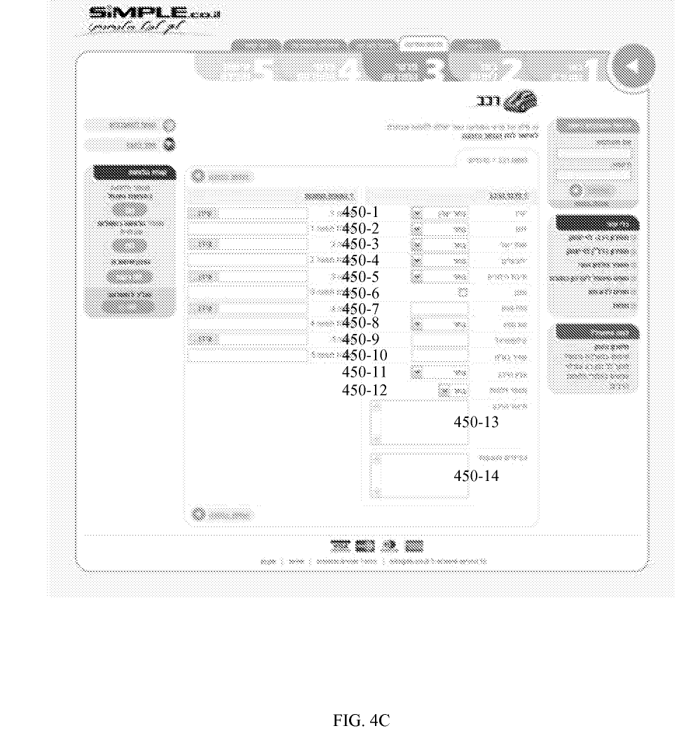

At S320, on the home page of the posting website the categories under which the user can advertise the classified ad are displayed, and the user is prompted to select a category. The selection is done, for example, by clicking on a hypertext link or on an icon associated with category. FIG. 4A shows an exemplary screenshot of a home page 400 of a posting website that includes eight different categories 410-1 through 410-8. For example, a category 410-1 is Real-Estate, a category 410-2 is Automotive, and a category 410-3 is Employment. Optionally, the user may be also prompted to select a subcategory. For instance, if the user selects Automotive category 410-2, the subcategory is the type of the vehicle, e.g., private, trunk, motorcycle, van, and the likes.

At S330, based on the selected category and subcategory, a search is made in database 220 to identify posting boards that the user can publish the classified ad on. Database 220 is preconfigured with a list of websites that includes posting boards. For each posting board, the type of the board and the advertising fees are specified. The websites in database 220 may be manually defined by a system administrator or automatically inserted using, for example, a web crawler (i.e., a program that searches for information on the web). At S335, a list of identified posting boards (or websites) is displayed. FIG. 4B provides an exemplary screenshot showing a list of identified posting boards 420-1 through 420-26. A classified ad created by the user will be sent to all identified boards 420 (e.g., board 420). The user may remove a board from the list or add a posting that is not shown.

At S340, based on the selected category and subcategory, a master form is retrieved from database 220 and the user is prompted to fill in the form. FIG. 4C shows an exemplary screenshot depicting a master form 440 of an Automotive category. Master form 440 includes a plurality of fields 450, some are text fields (e.g., field 450-7) and other are selection fields (e.g., fields 450-1 and 450-6). A selection field includes, but is not limited to, a combo box, a radio button, a check box, and the likes. Once the user completes filling the required information in the master form, it may be saved as an ad template in database 220. At S350, the information in the master form is automatically inserted to the respective information forms of the designated posting boards.

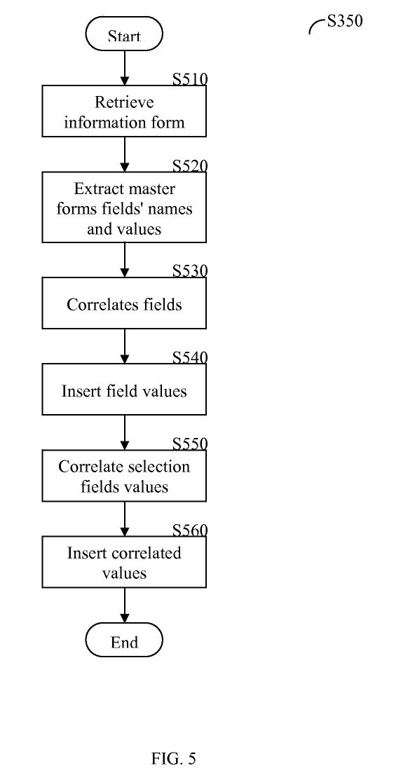

Referring now to FIG. 5, the execution of S350 is shown in greater detail. For the purpose of sending information encapsulated in the master form two tables: a field correlation table (FCT) and a value correlation table (VCT) are utilized. The FCT links between fields in information forms and fields in the master forms. Specifically, the FCT includes pairs of HTML tag names of input fields (extracted from an information form) and field names in the master form: As an example, for the following HTML code:

First Name: <input type=“text” name=“fname”/>

the field name is “First Name” and the tag name is “fname”.

The VCT correlates between display values and tag values of selection fields. As another example, for the following HTML code:

<select>
<option value =“1”>Volvo</option>
<option value =“2”>Saab</option>
<option value =“3” selected=“selected”>Opel</option>
<option value =“4”>Audi</option>
</select>

The tag values are 1, 2, 3, and 4 and the displayed values are Volvo, Saab, Opel, and Audi. The displayed values are part of the master form and the tag values are coded in the information form. That is, the VCT includes pairs of displayed values and tag values. The process for generating the VCT and FCT will be described in detail below. The VCT and FCT are kept in database 220.

At S510, all the information forms belonging to the selected posting boards and category are retrieved from database 220. At S520, the master form (filled out at S340) is analyzed and all its fields' names and values are extracted. At S530, the process, using the FCT, correlates between the fields' names in the master form and tag names in each information form. At S540, extracted fields' values are inserted to the corresponded fields in the information form. For instance, a user enters in the “First Name:” field the value “John”; this field is defined in an information form by the HTML code:

<input type=“text” name=“fname”/>.

In this example, “John” will be inserted to the information form to a field having a tag name “fname”.

At S550, the process, using the VCT, correlates between selected values of selection fields in the master form and tag values in the information form. At S560, the tag values are inserted to the information form. For instance, for the above example, if the user selects “Volvo”, then the value “1” is inserted to the information form.

Referring back to FIG. 3, at S360 the completed information forms are simultaneously sent to all posting boards (i.e., websites) designated by the user. Specifically, an information form is sent from post server 210 to a web server 230 to a URL of the posting board. The form is submitted using a communication protocol, such as the hypertext transfer protocol (HTTP). In some cases an information form may comprise a series of HTML pages that should be sent in a predefined order. In such cases, post server 210 submits the first page, waits for a response from a web server 230 then submits the second page, and so forth. Post server 210 is further capable of adaptively learning responses sent from websites 230. That is, if an unrecognized response is received the post server 210 parses it and saves the unique attributes of the response in database 220. In accordance with another embodiment web servers that host the designated posting boards can access post server 210 and pull the completed information forms.

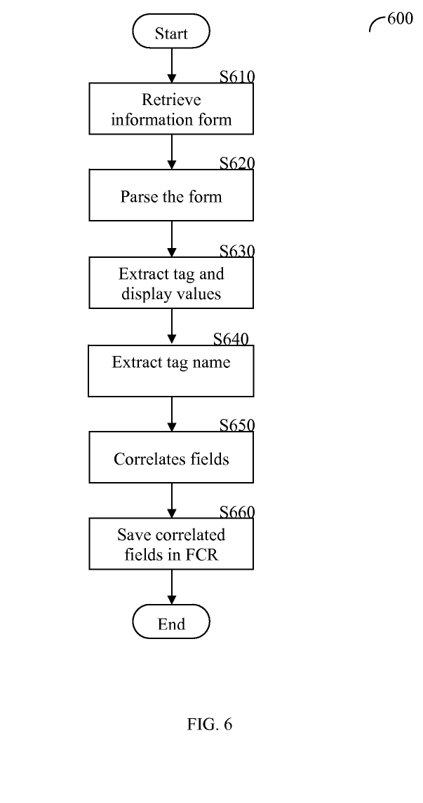

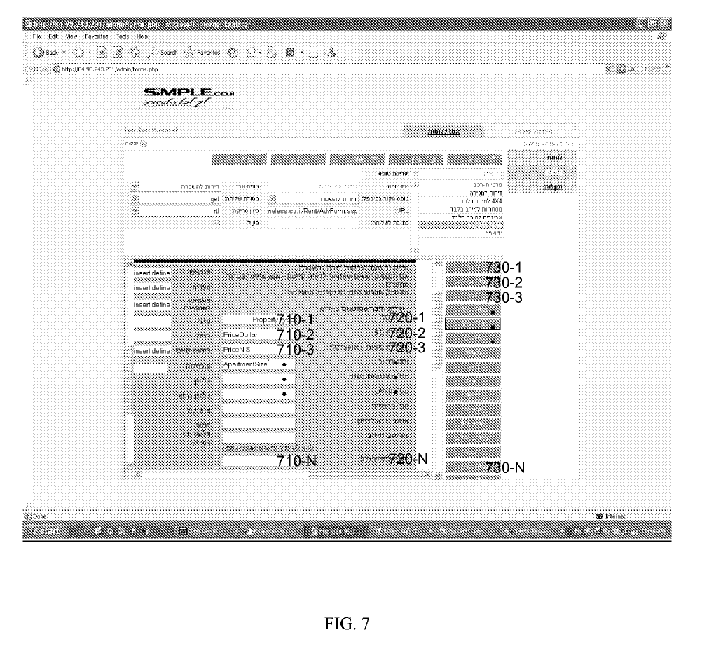

FIG. 6 shows a non-limiting and exemplary flowchart 600 describing the process for generating the FCT and VCT according to one embodiment of the present invention. At S610, post server 210 retrieves an information form from a predefined URL. At S620, the retrieved form is parsed for the purpose of identifying all fields in the form. At S630, for each selection field the displayed value and the tag value are extracted and saved in the VCT. At S640, all tag names of input tags are extracted, and subsequently at S650, each field in the information form is associated with a corresponded field in the master form. That is, tag names are correlated with field names. This can be preformed automatically by post server 210 or manually by a system administrator. At S660, pairs of fields' names (in the master form) and tag names (in the information form) are saved in the FCT. FIG. 7 provides an exemplary screenshot 700 showing the linkage between fields in the master and information form as preformed by a system administrator. The master form's fields are labeled as 710 while the information form's fields are labeled as 720. The system links between fields 710 and 720 by clicking on the corresponded button 730.

In accordance with another embodiment of the present invention a forms management system is provided. The management system may be embedded in post server 210 or may be implemented as an external system. The forms management system allows for saving and updating the ad templates. In addition, the system can generate reports that include the number of classified ads submitted by each user and to which websites the ads were submitted.

Most preferably, the principles of the present invention are implemented as a combination of hardware and software. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

It is to be further understood that, because some of the constituent system components and methods depicted in the accompanying drawings may be implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicants thus regards any means that can provide those functionalities as equivalent to those shown herein.

What is claimed is:

1. A method for simultaneously distributing a classified advertisement (ad) to a plurality of posting boards, comprising:
retrieving a master form filled out by a user;
automatically inserting details included in the master form into each information form of each posting board; and
posting each information form to its respective posting board.

2. The method of claim 1, wherein the posting boards are hosted by web-sites and each information form is sent via a network to a server for each web-site.

3. The method of claim 1, wherein the posting boards are hosted by web-sites and a server for each web-site pulls the information form from a server containing the information form.

4. The method of claim 1, wherein each of the information forms is different from the master form and said automatically inserting includes correlating between selected values of selection fields in the master form and tag values in the information form.

5. The method of claim 1, wherein the details in the master from includes information related to the classified ad.

6. The method of claim 5, wherein filling out the master form further comprising:
selecting a category of the classified ad; and
selecting one or more posting boards.

7. The method of claim 5, wherein for each category there is a different master form.

8. The method of claim 7, wherein the user is prompted to fill a master form respective of the selected category.

9. The method of claim 1, wherein automatically inserting details into the information forms further comprising:
retrieving from the information forms related to the selected category and the selected posting boards;
correlating, using field correlation table (FCT), between fields' names in the master form and fields' names in each of the information forms;
correlating, using a value correlation table (VCT), between selection fields' values in the master form and selection fields' values in each of the information form;
extracting fields' values from the master form; and
inserting the extracted fields' values to the corresponded fields in each of the information forms.

10. A computer program product including a computer-readable medium comprising software instructions operable to enable a computer to perform a method for simultaneously distributing a classified advertisement (ad) to a plurality of posting boards, comprising:
retrieving a master form filled out by a user;
automatically inserting details included in the master form into each information form of each posting board; and
posting each information form to its respective posting board.

11. The computer program product of claim 10, wherein the posting boards are hosted by websites and each information form is sent via a network to a server for each web-site.

12. The computer program product of claim 10, wherein the posting boards are hosted by web-sites and a server of each web-site pulls the information form from a server containing the information form.

13. The computer program product of claim 10, wherein each of the information forms is different from the master form and said automatically inserting includes correlating between selected values of selection fields in the master form and tag values in the information form.

14. The computer program product of claim 10, wherein the details in the master from includes information related to the classified ad.

15. The computer program product of claim 14, wherein filling out the master form further comprising:
selecting a category of the classified ad;
selecting one or more posting boards.

16. The computer program product of claim 14, wherein for each category there is a different master form.

17. The computer program product of claim 16, wherein the user is prompted to fill a master form respective of the selected category.

18. The computer program product of claim 10, wherein automatically inserting details into the information forms further comprising:
retrieving from the information forms related to the selected category and the selected posting boards;
correlating, using field correlation table (FCT), between fields' names in the master form and fields' names in each of the information forms;
correlating, using a value correlation table (VCT), between selection fields' values in the master form and selection fields' values in each of the information form;
extracting fields' values from the master form; and
inserting the extracted fields' values to the corresponded fields in each of the information forms.

19. A system for simultaneously posting a classified advertisement (ad) to a plurality of posting boards hosted by websites comprises:
a post server; and
a database for maintaining a plurality of information forms of and a plurality of master forms;
wherein the post server is capable of:
providing a master form to be filled out by a user;
automatically inserting details included in the master form into each information form of each posting board; and
posting each of the information forms to its respective posting board.

20. The system of claim 19, wherein the posting by the post server includes a website retrieving an information form from said post server.
